(19) United States
(12) Patent Application Publication
(10) Pub. No.: US 2026/0168819 A1
(43) Pub. Date: Jun. 18, 2026

(54) DETERMINING AN INTERNAL CALIBRATION REFERENCE FOR A TOTAL STATION

(71) Applicant: Trimble Inc., Westminster, CO (US)

(72) Inventors: Magnus Westermark, Danderyd (SE); Otto Manneberg, Danderyd (SE)

(73) Assignee: Trimble Inc., Westminster, CO (US)

(21) Appl. No.: 19/531,524

(22) Filed: Feb. 5, 2026

Related U.S. Application Data
(63) Continuation of application No. PCT/EP2023/072933, filed on Aug. 21, 2023.

(51) Int. Cl. G01C 25/00; G01C 15/00

(52) U.S. Cl. CPC G01C 25/00; G01C 15/002

(57) ABSTRACT

The present inventive concept relates to a total station (10), a calibration method (70) for a total station, and a method (60) for determining an internal calibration reference for a total station. The method (60) comprises: determining (S600) an alignment error of an optical axis (1030, 1032, 1034) of a reference measurement channel relative to the sighting axis (150) of the total station (10), wherein the reference measurement channel is a measurement channel (1022) comprising the light source or a measurement channel (1020, 1024) comprising the image sensor; rotating (S602) the sighting axis (150) of the total station (10) about the rotation point to a predetermined position at which a light beam emitted from the light source exits the center unit (100) via an objective (1000) of the center unit (100) and, after reflection at a reflective optical element (112) fixedly coupled to the alidade (110), enters the center unit (100) via the objective (1000) for propagation towards the image sensor; emitting (S604) a light beam from the light source; capturing (S606) an image with the image sensor; identifying (S608) a position of the light beam in the image; and determining (S610) an internal calibration reference of the total station (10) based on the determined alignment error of the optical axis (1030, 1032, 1034) of the reference measurement channel and the identified position of the light beam in the image.

### CROSS-REFERENCE TO RELATED APPLICATIONS

This application is a continuation of International Application No. PCT/EP2023/072933, filed Aug. 21, 2023, the entire contents of which are incorporated herein by reference for all purposes.

### TECHNICAL FIELD

The present inventive concept relates to a total station, a method for determining an internal calibration reference for a total station, and a calibration method for a total station.

### BACKGROUND OF THE INVENTION

Land surveying is a technique of measuring and mapping physical features of the environment (e.g., land or terrain). This technique is typically used within land development, construction planning, and infrastructure projects, to name a few. Land surveying typically involves using special equipment such as total stations to determine detailed information of the environment, e.g., positions of geographical points, as well as distances and angles between these points.

A total station is a device that typically integrates an electronic distance measurement unit (EDM unit) with a movable center unit (telescope) for rotation about at least two axes (typically a trunnion, or elevation, axis and an azimuth axis). The center unit is typically mounted on an alidade for rotation about a first axis (e.g., the trunnion axis) and the alidade is, in turn, typically mounted on a base for rotation about a second axis (e.g., the azimuth axis) intersecting (e.g., being orthogonal to) the first axis, such that a sighting axis of the total station is rotatable about a rotation point (typically corresponding to the intersection between the first axis and the second axis). During use, the total station is typically set up such that the first axis is oriented in the horizontal plane and the second axis is oriented in the vertical direction. Thus, the sighting axis of the total station is defined as an axis of the center unit that is orthogonal to the first axis, i.e., the axis about which the center unit is rotatable relative to the alidade. The sighting axis is also the axis along which a measurement is intended to be performed using the center unit by means of one or more of a plurality of measurement devices of the center unit (e.g., using the EDM unit).

Ideally, the optical axes of these devices (or measurement channels) should be aligned with the sighting axis. However, this may not always be the case due to mechanical imperfections, e.g., in case the first axis and the second axis not being orthogonal or the sighting axis of the total station not being orthogonal to the first axis. This can also change over time due to influence from the environment, such as temperature variations, mechanical impacts, etc. There is therefore a need of calibrating the total station, not only in factory but also on-site, in order to determine, and possibly compensate for, any alignment errors between the sighting axis and the optical axes associated with the plurality of measuring devices of the center unit. A technique for calibrating total stations involves repeated measurements towards a target using different faces, e.g., Face 1 and Face 2. Any differences between the Face 1 and Face 2 measurements will be indicative of alignment errors between the sighting axis of the total station and the optical axis associated with the measurement device used for the repeated measurements. However, this technique may be time-consuming since several measurements are needed in order to calibrate the total station (e.g., the total station may comprise multiple optical axes). Further, the technique also requires the presence of one or more suitable targets which can be used for the Face 1 and Face 2 measurements. Thus, there exists a need for improvement within the art.

### SUMMARY OF THE INVENTION

In view of the above, it is an object of the present inventive concept to provide a method for determining an internal calibration reference which allows for calibrating a total station in a more efficient and/or less time-consuming manner.

A further objective is to provide a method for determining an internal calibration reference which allows for calibrating a total station without needing an external target.

A further object is to provide a total station capable of determining an internal reference which allows the total station to efficiently calibrate its sighting axis and optical axes associated with measurement channels, for instance in a less time-consuming manner.

A further objective is to provide a total station capable of determining an internal reference which allows the total station to calibrate its sighting axis and optical axes associated with measurement channels without using an external target.

A further object is to, at least partly, mitigate, alleviate or eliminate one or more of the above-identified deficiencies in the art and disadvantages singly or in any combination and solve at least the above-mentioned problem.

According to a first aspect, a method for determining an internal calibration reference for a total station is provided. The total station comprising a center unit mounted on an alidade for rotation about a first axis, wherein the alidade is mounted on a base of the total station for rotation about a second axis orthogonal to the first axis, whereby a sighting axis of the total station is rotatable about a rotation point, wherein the center unit comprises a plurality of measurement channels, each measurement channel having an optical axis, wherein at least one measurement channel of the plurality of measurement channels comprises a light source, and wherein at least one measurement channel of the plurality of measurement channels comprises an image sensor. The method comprising: determining an alignment error of an optical axis of a reference measurement channel relative to the sighting axis of the total station, wherein the reference measurement channel is a measurement channel comprising the light source or a measurement channel comprising the image sensor; rotating the sighting axis of the total station about the rotation point to a predetermined position at which a light beam emitted from the light source exits the center unit via an objective of the center unit and, after reflection at a reflective optical element fixedly coupled to the alidade, enters the center unit via the objective for propagation towards the image sensor; emitting a light beam from the light source; capturing an image with the image sensor; identifying a position of the light beam in the image; and determining an internal calibration reference of the total station based on the determined alignment error of the optical axis of the reference measurement channel and the identified position of the light beam in the image.

The wording “fixedly coupled” should, within the context of this disclosure, be construed as an entity being substantially stationary relative to a different entity. Hence, the wording “a reflective optical element fixedly coupled to the alidade” should be construed as the reflective optical element is substantially stationary relative to the alidade, possibly with one or two degrees of freedom in a plane parallel to a surface of the optical reflective element. For instance, the reflective optical element may be attached to the alidade using fastening means, e.g., an adhesive and/or spring clips pressing against posts. Alternatively, the reflective optical element may be a polished surface of the alidade. Alternatively, the reflective optical element may be enclosed in, and/or form part of, the alidade but retain a certain freedom of movement (controlled and/or uncontrolled) in a predefined plane such that a normal vector of the predefined plane is fixed relative to the alidade. Thus, the wording “a reflective optical element fixedly coupled to the alidade” in this context may be construed as the reflective optical element” forming part of the alidade. Furthermore, the reflective optical element may be mounted on mechanical actuators and a direction of a normal of a reflective surface of the reflective optical element relative to the alidade may be monitored by one or more sensors. The actuators may be piezoelectric. The one or more sensors may be capacitive and/or differential sensors. The one or more sensors may be coupled in a feedback loop ensuring that the normal of the reflective surface of the reflective optical element is fixed relative to the alidade.

By means of the present inventive concept, an internal calibration reference is determined which allows the total station to be calibrated without using an external calibration reference (e.g., an external target). Put differently, the external calibration reference used when determining the alignment error of the optical axis of the reference measurement channel relative to the sighting axis of the total station is transferred to the internal calibration reference, and the external calibration reference is no longer needed when calibrating the total station. Thus, a more efficient and less time-consuming method for calibrating the total station is allowed. The reflective optical element may be a mirror configured to specularly reflect light emitted by the light source.

An associated advantage is that an amount of reflected light may be increased, in particular in comparison to using a polished surface.

A further associated advantage is that a reflective surface may be more flat. This, in turn, may reduce an effect of the reflective optical element on a profile of the reflected light beam.

A further associated advantage is that the reflective optical element may be manufactured using conventional processes.

A further associated advantage is that existing total stations may be retrofitted with a mirror, and may thereby be capable of determining the internal calibration reference according to the present inventive concept.

An angle of incidence of the light beam at the reflective optical element may be smaller than an angle corresponding to a field-of-view associated with the image sensor when the sighting axis of the total station is at the predetermined position. Put differently, the angle of incidence of the light beam is such that after reflection at the reflective optical element, a reflected light beam is within the field-of-view of the image sensor.

Accordingly, the light beam may thereby, after reflection at the reflective optical element, be allowed to enter the center unit via the objective, and thereby be allowed to be detected by the image sensor of the center unit.

An associated advantage is that the center unit may be more compact, since an angle of reflection of light reflected by the reflective optical element may be similar to the angle of incidence. Thus, the light beam reflected by the reflective optical element may be detected by the total station without needing a dedicated measurement channel configured for only that purpose.

A further associated advantage is that the same measurement channel (i.e., the measurement channel comprising the image sensor) may be used to detect the reflected light beam and light emanating from the scene (when the total station is in use). Thus, there may be no need for a separate (or dedicated) measurement channel configured only to detect the reflected light beam.

The reference measurement channel may be associated with a measuring device, and determining the alignment error of the optical axis of the reference measurement channel may comprise: performing, using the measuring device associated with the reference measurement channel, a first measurement in a first face of the total station; performing, using the measuring device associated with the reference measurement channel, a second measurement in a second face of the total station, wherein, in the second face, the center unit may be rotated around each one of the first axis and the second axis of the total station by 180°compared to the first face; and comparing the first measurement and the second measurement, whereby the alignment error of an optical axis of the reference measurement channel relative to the sighting axis of the total station may be determined.

An associated advantage is that the reference measurement channel may be calibrated relative to an external calibration reference (e.g., an external target). This, in turn, may allow the internal calibration reference to be determined using a reference measurement channel being calibrated relative to the external calibration reference. Put differently, calibrating the total station using the internal calibration reference may correspond to calibrating the total station using the external calibration reference.

The reference measurement channel may be the measurement channel comprising the image sensor.

The measurement channel comprising the light source and the measurement channel comprising the image sensor may be different measurement channels.

The method may further comprise: determining a relative alignment error of the optical axis of the measurement channel comprising the light source and the optical axis of the measurement channel comprising the image sensor.

An associated advantage is that a relative alignment error of the optical axis of the measurement channel comprising the light source and the optical axis of the measurement channel comprising the image sensor, if present, may be compensated, whereby the internal calibration reference may to a higher degree correspond to the external calibration reference. It may, in particular, be advantageous to determine (and possibly compensate for) this relative alignment error in case the measurement channel comprising the light source and the measurement channel comprising the image sensor are different measurement channels.

Determining a relative alignment error of the optical axis of the measurement channel comprising the light source and the optical axis of the measurement channel comprising the image sensor may comprise: rotating the sighting axis of the total station about the rotation point to a further predetermined position at which a light beam emitted from the light source may exit the center unit via the objective of the center unit and, after reflection at a retroreflecting optical element, may enter the center unit via the objective for propagation towards the image sensor; emitting a light beam from the light source; capturing a further image with the image sensor; and determining, based on a position of the light beam in the further image, the relative alignment error of the optical axis of the measurement channel comprising the light source and the optical axis of the measurement channel comprising the image sensor.

Conventionally, the alignment of a measurement channel relative to the sighting axis of the total station may be determined using the internal calibration reference or an external calibration reference (e.g., using the Face 1 and Face 2 technique described above), which means that this procedure needs to be repeated for each measurement channel of the plurality of measurement channels of the center unit. Due to the amount of measurements needed, the process of calibrating each measurement channel of the plurality of measurement channels may be time consuming. Thus, determining the relative alignment error between optical axes of different measurement channels using the retroreflector may allow for only needing to calibrate one measurement channel relative to the sighting axis of the total station, while alignments of the other measurement channels may be determined relative to that measurement channel.

Further, when the total station is calibrated (or its calibration verified) using the internal calibration reference, a current relative alignment error of the optical axis of the measurement channel comprising the light source and the optical axis of the measurement channel comprising the image sensor may be compared to the determined relative alignment error. This may, in turn, allow the total station (or a user thereof) to verify whether any changes of the alignment between these channels have changed, and may thereafter take appropriate action.

According to a second aspect, a calibration method for a total station using an internal calibration reference determined according to the method of the first aspect is provided. The total station comprises a center unit mounted on an alidade for rotation about a first axis, wherein the alidade is mounted on a base of the total station for rotation about a second axis orthogonal to the first axis, whereby a sighting axis of the total station is rotatable about a rotation point, wherein the center unit comprises a plurality of measurement channels, each measurement channel having an optical axis, wherein at least one measurement channel of the plurality of measurement channels comprises a light source, and wherein at least one measurement channel of the plurality of measurement channels comprises an image sensor. The calibration method comprising: rotating the sighting axis of the total station about the rotation point to a predetermined position at which the internal calibration reference is determined and at which a light beam emitted from the light source exits the center unit via an objective of the center unit and, after reflection at a reflective optical element, enters the center unit via the objective for propagation towards the image sensor; emitting a light beam from the light source; capturing an image with the image sensor; identifying a position of the light beam in the image; and comparing the identified position of the light beam in the image with the internal calibration reference, thereby determining an alignment error of an optical axis of a reference measurement channel relative to the sighting axis of the total station.

The calibration method may further comprise: determining a current relative alignment error of the optical axis of the measurement channel comprising the light source and the optical axis of the measurement channel comprising the image sensor; and verifying a relative alignment of the optical axis of the measurement channel comprising the light source and the optical axis of the measurement channel comprising the image sensor by comparing the current relative alignment error with the relative alignment error determined according to the method of the first aspect.

The calibration method may further comprise: comparing the determined alignment error of the optical axis of the reference measurement channel relative to the sighting axis of the total station with a range of allowed threshold errors; and upon the determined alignment error being outside the range of allowed threshold errors: alarming a user of the total station that the determined alignment error of the optical axis of the reference measurement channel relative to the sighting axis of the total station is outside the range of allowed threshold errors.

The above-mentioned features of the first aspect, when applicable, apply to this second aspect as well. In order to avoid undue repetition, reference is made to the above.

According to a third aspect, a total station is provided. The total station comprising: a center unit comprising a plurality of measurement channels, each measurement channel having an optical axis, wherein at least one measurement channel of the plurality of measurement channels comprises a light source, and wherein at least one measurement channel of the plurality of measurement channels comprises an image sensor; an alidade on which the center unit is mounted for rotation about a first axis; a base on which the alidade is mounted for rotation about a second axis orthogonal to the first axis, whereby a sighting axis of the total station is rotatable about a rotation point; a reflective optical element fixedly coupled to the alidade; and circuitry configured to execute: an alignment error determination function configured to determine an alignment error of an optical axis of a reference measurement channel relative to the sighting axis of the total station, wherein the reference measurement channel is a measurement channel comprising the light source or a measurement channel comprising the image sensor, a rotation function configured to rotate the sighting axis of the total station about the rotation point to a predetermined position at which a light beam emitted from the light source exits the center unit via an objective of the center unit and, after reflection at the reflective optical element, enters the center unit via the objective for propagation towards the image sensor, a light source control function configured to control the light source to emit a light beam, an image sensor control function configured to control the image sensor to capture an image, a position identification function configured to identify a position of the light beam in the image, and an internal calibration reference determination function configured to determine an internal calibration reference of the total station based on the determined alignment error of the optical axis of the reference measurement channel and the identified position of the light beam in the image.

The reflective optical element may be a mirror configured to specularly reflect light emitted by the light source.

An angle of incidence of the light beam at the reflective optical element may be smaller than an angle corresponding to a field-of-view associated with the image sensor when the sighting axis of the total station is at the predetermined position.

The reference measurement channel may be associated with a measuring device, and wherein the alignment error determination function may be configured to determine an alignment error of an optical axis of the reference measurement channel relative to the sighting axis of the total station by being configured to: perform, using the measuring device associated with the reference measurement channel, a first measurement in a first face of the total station; rotate the center unit about the rotation point to a second face of the total station, wherein, in the second face, the center unit may be rotated around each one of the first axis and the second axis of the total station by 180° compared to the first face; perform, using the measuring device associated with the reference measurement channel, a second measurement in the second face of the total station; and compare the first measurement and the second measurement, whereby the alignment error of an optical axis of the reference measurement channel relative to the sighting axis of the total station may be determined.

The reference measurement channel may be the measurement channel comprising the image sensor.

The circuitry may be further configured to execute: a calibration function configured to: rotate the sighting axis of the total station about the rotation point to the predetermined position; control the light source to emit a light beam; control the image sensor to capture a second image; identify a position of the light beam in the second image; and compare the identified position of the light beam in the image with the internal calibration reference, thereby determining an alignment error of an optical axis of a reference measurement channel relative to the sighting axis of the total station.

The measurement channel comprising the light source and the measurement channel comprising the image sensor may be different measurement channels.

The circuitry may be further configured to execute: a relative alignment error determination function configured to determine a relative alignment error of the optical axis of the measurement channel comprising the light source and the optical axis of the measurement channel comprising the image sensor.

The total station may further comprise: a retroreflecting optical element; and wherein the relative alignment error determination function may be configured to determine the relative alignment error of the optical axis of the measurement channel comprising the light source and the optical axis of the measurement channel comprising the image sensor by being configured to: rotate the sighting axis of the total station about the rotation point to a further predetermined position at which a light beam emitted from the light source may exit the center unit via the objective of the center unit and, after reflection at the retroreflecting optical element, may enter the center unit via the objective for propagation towards the image sensor; control the light source to emit a light beam; control the image sensor to capture a further image; and determine, based on a position of the light beam in the further image, the relative alignment error of the optical axis of the measurement channel comprising the light source and the optical axis of the measurement channel comprising the image sensor.

The circuitry may be further configured to execute: a relative alignment verification function configured to: determine a current relative alignment error of the optical axis of the measurement channel comprising the light source and the optical axis of the measurement channel comprising the image sensor, and verify a relative alignment of the optical axis of the measurement channel comprising the light source and the optical axis of the measurement channel comprising the image sensor by comparing the current relative alignment error with the relative alignment error determined by the relative alignment error determination function.

The above-mentioned features of the first aspect and/or second aspect, when applicable, apply to this third aspect as well. In order to avoid undue repetition, reference is made to the above.

Further features of, and advantages with, the present inventive concept will become apparent when studying the appended claims and the following description. The skilled person will realize that different features of the present inventive concept may be combined to create variants other than those described in the following, without departing from the scope of the present inventive concept.

### BRIEF DESCRIPTION OF THE DRAWINGS

The aspects of the present inventive concept, including its particular features and advantages, will be readily understood from the following detailed description and the accompanying drawings, in which:

FIG. 1 illustrates a total station.

FIG. 2 is a schematic illustration of circuitry.

FIG. 3 illustrates an interior of a center unit of a total station.

FIG. 4 illustrates an alternate view of a total station.

FIG. 5 illustrates a total station comprising a retroreflecting optical element.

FIG. 6 is a block scheme of a method for determining an internal calibration reference for a total station.

FIG. 7 is a block scheme of a calibration method for a total station using an internal calibration reference determined according to the method illustrated in FIG. 6.

FIG. 8 is a schematic illustration of a cross section of an alidade.

### DETAILED DESCRIPTION

The present inventive concept will now be described more fully hereinafter with reference to the accompanying drawings, in which currently preferred variants of the inventive concept are shown and discussed. This inventive concept may, however, be implemented in many different forms and should not be construed as limited to the variants set forth herein; rather, these variants are provided for thoroughness and completeness, and fully convey the scope of the present inventive concept to the skilled person. As illustrated in the figures, features may be exaggerated for illustrative purposes and, thus, may be provided to illustrate the general structures of variants of the present inventive concept. Like reference numerals refer to like elements throughout the description.

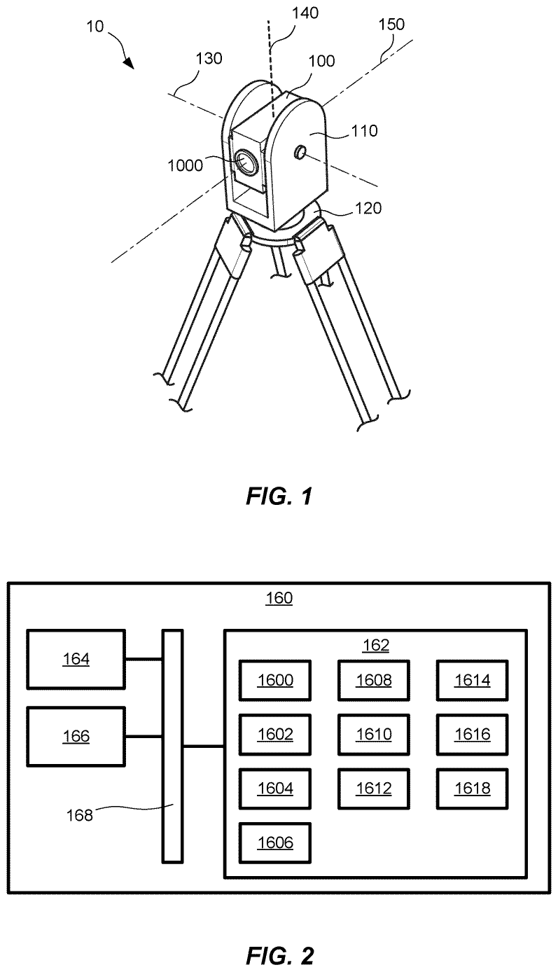

FIG. 1 illustrates a total station 10. The total station 10 may be configured to survey a scene (e.g., an environment or terrain in a vicinity of the total station), and to measure distances to points in the scene. Further, the total station 10 may be configured to determine angles between the points in the scene. As is seen in the example of FIG. 1, the total station 10 comprises a center unit 100, an alidade 110, and a base 120.

The center unit 100 is mounted on the alidade 110 for rotation about a first axis 130. The first axis 130 may be parallel to a horizontal plane when the total station 10 is in use. The first axis 130 may be a trunnion axis. The alidade 110 is mounted on the base 120 for rotation about a second axis 140 orthogonal to the first axis 130. Thus, a sighting axis 150 of the total station 10 is rotatable about a rotation point (not illustrated in FIG. 1). The sighting axis 150 may be referred to as a “collimation axis” within the art. The sighting axis 150 may be orthogonal to the first axis 130. The rotation point may be defined by the first axis 130 and the second axis 140. The rotation point may be defined by an intersection between the first axis 130 and the second axis 140. The total station 10 may further comprise one or more motors (not illustrated in FIG. 1) configured to rotate the sighting axis 150 of the total station 10 about the rotation point.

The total station 10 further comprises circuitry 160. Even though the circuitry 160 is not explicitly illustrated in FIG. 1, it is to be understood that the circuitry 160 may be comprised in one or more of the center unit 100, the alidade 110, and the base 120. It is further to be understood that the circuitry 160 may be comprised by an external unit (not illustrated in FIG. 1), e.g., a handheld unit configured to control the total station 10. The handheld unit may further be configured to display measurement results determined by the total station 10. The circuitry 160 is illustrated in FIG. 2. The circuitry 160 is configured to execute an alignment error determination function 1600, a rotation function 1602, a light source control function 1604, an image sensor control function 1606, a position identification function 1608, and an internal calibration reference determination function 1610. The circuitry 160 may be further configured to execute one or more of a calibration function 1612, a relative alignment error determination function 1614, and a relative alignment verification function 1616. As is illustrated in the example of FIG. 2, the circuitry 160 may comprise one or more of a memory 162, a processing unit 164, a transceiver 166, and a data bus 168. The memory 162, the processing unit 164, and the transceiver 166 may communicate via the data bus 168. The processing unit 164 may comprise a central processing unit (CPU) and/or a graphical processing unit (GPU). The transceiver 166 may be configured to communicate with external devices. For example, the transceiver 166 may be configured to communicate with servers, computer external peripherals (e.g., external storage), etc. The external devices may be local devices or remote devices (e.g., a cloud server). As a further example, in case the circuitry 160 is comprised in the external unit (e.g., the handheld unit), the circuitry 160 may communicate with, and control, the total station 10 via the transceiver 166. The transceiver 166 may be configured to communicate with the external devices via an external network (e.g., a local-area network, the internet, etc.). The transceiver 166 may be configured for wireless and/or wired communication. Suitable technologies for wireless communication are known to the skilled person. Some non-limiting examples comprise Wi-Fi, Bluetooth, and Near-Field Communication (NFC). Suitable technologies for wired communication are known to the skilled person. Some non-limiting examples comprise USB, Ethernet, and Firewire.

The memory 162 may be a non-transitory computer-readable storage medium. The memory 162 may be a random-access memory. The memory 162 may be a non-volatile memory. As is illustrated in the example of FIG. 2, the memory 162 may store program code portions 1600, 1602, 1604, 1606, 1608, 1610, 1612, 1614, 1616 corresponding to one or more functions. The program code portions 1600, 1602, 1604, 1606, 1608, 1610, 1612, 1614, 1616 may be executable by the processing unit 164, which thereby performs the functions. Hence, when it is referred to that the circuitry 160 is configured to execute a specific function, the processing unit 164 may execute program code portions 1600, 1602, 1604, 1606, 1608, 1610, 1612, 1614, 1616, 1618 corresponding to that specific function which may be stored on the memory 162. However, it is to be understood that one or more functions of the circuitry 160 may be hardware implemented and/or implemented in a specific integrated circuit. For example, one or more functions may be implemented using field-programmable gate arrays (FPGAs). Put differently, one or more functions of the circuitry 160 may be implemented in hardware or software, or as a combination of the two.

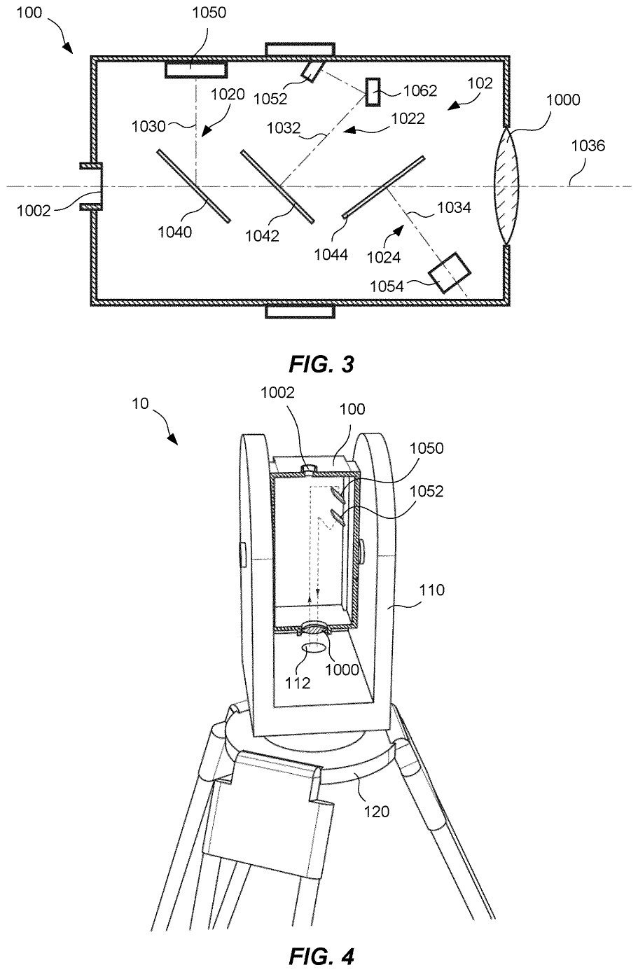

As is further illustrated in FIG. 1, the center unit 100 comprises an objective 1000. The objective 1000 may be a front lens. An example of an interior of the center unit 100 is illustrated in FIG. 3. As is seen in the example of FIG. 3, the center unit 100 may further comprise an eyepiece 1002. The objective 1000 and the eyepiece 1002 may be arranged such that a user of the total station 10 may view a scene to be measured through the eyepiece 1002. In particular, the eyepiece 1002 may comprise a crosshair. The crosshair may be used to facilitate targeting. In other words, the crosshair may be used by the user of the total station 10 to target an object with the total station 10. As is further seen in FIG. 3, the center unit 100 comprises a plurality 102 of measurement channels. Each measurement channel 1020, 1022, 1024 may communicate with a surrounding of the center unit 100 via the objective 1000 of the center unit 100. Each measurement channel 1020, 1022, 1024 has an optical axis 1030, 1032, 1034. As is seen in the example of FIG. 3, the optical axes 1030, 1032, 1034 of the measurement channels 1020, 1022, 1024 may be redirected using optical components 1040, 1042, 1044. For instance, as in the example of FIG. 3, the optical axes 1030, 1032, 1034 of the measurement channels 1020, 1022, 1024 may preferably be redirected such that they partly overlap. As in the example of FIG. 3, the optical axes 1030, 1032, 1034 of the measurement channels 1020, 1022, 1024 may at least overlap in a section of the optical axes 1030, 1032, 1034 in a proximity of the objective 1000 (e.g., in a last section of the optical axes 1030, 1032, 1034 on their way through the objective 1000). Even more preferably, one or more of the optical axes 1030, 1032, 1034 of the measurement channels 1020, 1022, 1024 may be redirected such that they overlap a central axis 1036 of the center unit 100. An optical axis of the objective 1000 of the center unit 100 may be aligned with the central axis 1036 of the center unit 100. The optical components 1040, 1042, 1044 may be configured to partly reflect light and partly transmit light. The optical components 1040, 1042, 1044 may be beam splitters. The optical components 1040, 1042, 1044 may comprise a first optical component 1040, a second optical component 1042, and a third optical component 1044. Each optical component 1040, 1042, 1044 may be configured to transmit light having a wavelength in a respective wavelength range and to reflect light having a wavelength outside the respective wavelength range. At least one measurement channel 1022 of the plurality 102 of measurement channels comprises a light source. The light source may be a laser. As in the example of FIG. 3, the light source may form part of a measuring device 1052 associated with the measurement channel 1022. The measuring device 1052 may be an electronic distance measurement (EDM) unit. The EDM unit may be configured to measure a distance to an object (e.g., an external target) in the scene. The light source and/or the EDM unit may comprise beam-forming optics (not illustrated in FIG. 3). The beam-forming optics may be configured to collimate the light beam emitted by the light source. The beam-forming optics and the objective 1000 of the center unit 100 may be configured to collimate the light beam. The light beam may thereafter be a collimated light beam. Thus, the light beam may be collimated inside the center unit 100 and/or upon exiting the center unit 100 via the objective 1000. At least one measurement channel 1020, 1024 of the plurality 102 of measurement channels comprises an image sensor. As in the example of FIG. 3, the image sensor may be comprised in a measuring device 1050, 1054. The measuring device 1050, 1054 may be used for imaging of the scene, e.g., for finding external targets (e.g., surveying poles, and/or entities (windows, towers, etc.) on buildings). The measuring device 1050, 1054 may be a camera. For instance, the center unit 100 may comprise a first camera and a second camera each associated with a respective measurement channel 1020, 1024. Thus, the center unit 100 may comprise a first measuring device 1050, a second measuring device 1052, and a third measuring device 1054. The first measuring device 1050 and the third measuring device may each comprise an image sensor. For instance, the first measuring device 1050 and/or the third measuring device 1054 may be a camera, and the second measuring device 1052 may be an EDM unit. The camera 1050, 1054 may comprise imaging optics (not illustrated in FIG. 3). The imaging optics may be configured to image objects at a distance (e.g., a distance larger than 0.5 meter) onto the image sensor. The imaging optics may be configured to image objects at infinity onto the image sensor. The imaging optics and the objective 1000 of the center unit 100 may be configured to image objects onto the image sensor. For instance, the imaging optics and the objective 1000 of the center unit 100 may be configured to image objects at infinity onto the image sensor. As is further illustrated in the example of FIG. 3, the measurement channel 1022 comprising the light source and the measurement channel 1020, 1024 comprising the image sensor may be different measurement channels. As is seen in FIG. 3, even though the measurement channel 1022 comprising the light source and the measurement channel 1020, 1024 comprising the image sensor may be different measurement channels, some portions may be shared between the measurement channels. For instance, portions of the central axis 1036 of the center unit 100 may, as is illustrated in FIG. 3, be shared between the different measurement channels 1020, 1022, 1024.

A different view of the total station 10 is illustrated in FIG. 4. In FIG. 4, a simplified version of the interior of the center unit 100 is illustrated. As is seen in FIG. 4, the total station further comprises a reflective optical element 112. The reflective optical element 112 is fixedly coupled to the alidade 110. The reflective optical element 112 may be securely coupled to the alidade 110. Here, “fixedly coupled” should be understood as the reflective optical element 112 being substantially stationary relative to the alidade 110. To that end, the reflective optical element 112 may be attached to the alidade 110 using fastening means, e.g., by clamping (e.g., using springs) and/or by using an adhesive. The reflective optical element 112 may be clamped using a component of an elastic material, e.g., metal, rubber, plastic, etc. Alternatively, the reflective optical element 112 may form part of the alidade 110, e.g., as a portion of a casing of the alidade 110. For instance, the reflective optical element 112 may be a polished surface of the casing of the alidade 110. Thus, the wording “a reflective optical element fixedly coupled to the alidade” may be construed as the reflective optical element 112 forming part of the alidade 110. The reflective optical element 112 may be a mirror configured to specularly reflect light emitted by the light source. The mirror may be a silver mirror. The mirror may be a dielectric mirror. The mirror may be a flat mirror.

However, issues arise in case one or more of the optical axes 1030, 1032, 1034 of the plurality 102 of measurement channels are not aligned (e.g., not parallel and/or overlapping) with the sighting axis 150 of the total station 10. For instance, an optical axis 1030, 1032, 1034 may not be aligned with the center axis 1036 of the center unit 100 and/or the sighting axis 150 of the total station 10. As a further example, an optical axis 1030, 1032, 1034 may be aligned with the central axis 1036 of the center unit 100, while the central axis 1036 of the center unit 100 may not be aligned with the sighting axis 150 of the total station 10. In case one or more of the optical axes 1030, 1032, 1034 of the plurality 102 of measurement channels are not aligned with the sighting axis 150 of the total station 10, a user of the total station may target an object in the scene using the eyepiece 1002 of the center unit 100, while the non-aligned measurement channels may target a different object in the scene. Thus, the distance and/or other properties (e.g., angles) determined by the total station 10 may in this case be inaccurate. To avoid such issues, the optical axes 1030, 1032, 1034 of the measurement channels 1020, 1022, 1024 are typically aligned with respect to the sighting axis 150 of the total station 10. To that end, the alignment error determination function 1600 is configured to determine an alignment error of an optical axis 1030, 1032, 1034 of a reference measurement channel 1020, 1022, 1024 relative to the sighting axis 150 of the total station 10. The reference measurement channel is a measurement channel 1022 comprising the light source or a measurement channel 1020, 1024 comprising the image sensor. The reference measurement channel may be associated with a measuring device 1050, 1052, 1054. The reference measurement channel may be the measurement channel 1020, 1024 comprising the image sensor. The alignment error of the optical axis 1030, 1032, 1034 of the reference measurement channel relative to the sighting axis 150 of the total station 10 may be determined by using an external reference point (e.g., a target external to the total station 10). Thus, by determining the alignment error of the optical axis 1030, 1032, 1034 of the reference measurement channel and the sighting axis 150 of the total station 10, any misalignments between them may be accounted for and/or corrected. The skilled person realizes that there is a plurality of different manners in which the alignment error of the optical axis 1030, 1032, 1034 of the reference measurement channel relative to the sighting axis 150 of the total station 10 may be determined. For example, the alignment error determination function 1600 may be configured to determine the alignment error of the optical axis 1030, 1032, 1034 of a reference measurement channel relative to the sighting axis 150 of the total station 10 by being configured to perform, using the measuring device 1050, 1052, 1054 associated with the reference measurement channel, a first measurement in a first face of the total station 10. In the first face of the total station 10, the external reference point may be targeted by, for example, the eyepiece 1002 of the total station 10. Put differently, the total station 10 may in the first face be arranged to perform measurements of the external reference point. The first measurement may be based on a plurality of individual measurements. For instance, the first measurement may be an average of the plurality of individual measurements. It is to be understood that the first measurement may be determined in different manners from the plurality of individual measurements. For instance, the first measurement may be one or more of an average, a weighted average, a harmonic average, a median, etc. of the plurality of the individual measurements. The alignment error determination function 1600 may be further configured to rotate the center unit 100 about the rotation point to a second face of the total station 10. In the second face, the center unit 100 may be rotated around each one of the first axis 130 and the second axis 140 of the total station by 180° compared to the first face. The alignment error determination function 1600 may be further configured to perform, using the measuring device 1050, 1052, 1054 associated with the reference measurement channel, a second measurement in the second face of the total station 10. The second measurement may be based on a plurality of individual measurements. For instance, the second measurement may be determined in manners similar to those described in connection with the first measurement. The alignment error determination function 1600 may be further configured to compare the first measurement and the second measurement, whereby the alignment error of an optical axis 1030, 1032, 1034 of the reference measurement channel relative to the sighting axis 150 of the total station 10 may be determined. For instance, in case the reference measurement channel is the measurement channel 1020, 1024 comprising the image sensor (i.e., the first measurement and the second measurement are images captured using the image sensor), the alignment error may be determined by comparing positions of the external reference point in an image corresponding to the first measurement and in an image corresponding to the second measurement. In case the positions of the external reference point are the same in the images, the alignment error of optical axis 1030, 1034 of the reference measurement channel relative to the sighting axis 150 may be non-existent. However, in case there is a non-zero alignment error, a position between the positions of the external reference point in the images may correspond to the sighting axis 150 of the total station 10. Thus, by determining this alignment error, it may be accounted for and/or corrected. Even though the above has been described with the reference measurement channel being the measurement channel 1020, 1024 comprising the image sensor, it is to be understood that the reference measurement channel may be a measurement channel other than the measurement channel comprising the image sensor. For instance, the reference measurement channel may be the measurement channel 1022 comprising the light source. The first and second measurements may in such case be measurement performed using the measuring device 1052 associated with that measurement channel 1022. For example, the light source may form part of an EDM unit, and in such case the first and second measurements may be distance measurements. A difference between the first and second distance measurements may thereby be used to determine an alignment error between the optical axis 1032 of the reference measurement channel and the sighting axis 150 of the total station 10.

As is understood from the above, it may be time consuming and cumbersome to determine the alignment error for the reference measurement channel. For instance, this procedure requires the external reference point, and, typically, a plurality of individual measurements is made in order to properly determine the alignment error of the optical axis 1030, 1032, 1034 of the reference measurement channel relative to the sighting axis 150 of the total station 10.

To alleviate this drawback, the present inventive concept relates to determining an internal calibration reference which can be used to calibrate the total station 10 and/or validate a current alignment of the total station 10. To that end, the total station comprises the reflective optical element 112 which is used when the internal calibration reference is determined. In order to determine the internal calibration reference, the rotation function 1602 is configured to rotate the sighting axis 150 of the total station 10 about the rotation point to a predetermined position at which a light beam emitted from the light source exits the center unit 100 via the objective 1000 of the center unit 100 and, after reflection at the reflective optical element 112, enters the center unit 100 via the objective 1000 for propagation towards the image sensor. The rotation function 1602 may be configured to control motors (not illustrated in the figures) arranged to rotate the center unit 100 about the first axis 130 and/or the second axis 140. The predetermined position of the sighting axis 150 may be a predetermined direction of the sighting axis 150. The light beam may be emitted from the measuring device 1052 comprising the light source. After being emitted, the light beam may be reflected at a mirror 1062. After reflection at the mirror 1062, the light beam may propagate towards the second optical component 1042. A portion of the light beam may be reflected by the second optical component 1042, and a portion of that reflected portion may be transmitted by the third optical component 1044. After being transmitted by the third optical component 1044, the light beam (or a portion of the light beam) may exit the center unit 100 via the objective 1000. After reflection at the reflective optical element 112, the light beam may enter the center unit 100 via the objective 1000. A portion of that light beam may be reflected at the third optical component 1044, and then propagate towards the image sensor of the third measuring device 1054. Alternatively, or additionally, a portion of that light beam may be transmitted through the third optical component 1044 and the second optical component 1042. After transmission through the second optical component 1042, the transmitted portion of the light beam may be reflected by the first optical component 1040 towards the image sensor of the first measuring device 1050.

An angle of incidence of the light beam at the reflective optical element 112 may be smaller than an angle corresponding to a field-of-view associated with the image sensor when the sighting axis 150 of the total station 10 is at the predetermined position. The field-of-view associated with the image sensor may be 1°. Hence, the angle of incidence of the light beam at the reflective optical element 112 may be smaller than 1° when the sighting axis 150 of the total station 10 is at the predetermined position. Thus, when the sighting axis 150 of the total station 10 is at the predetermined position, the light beam may have close to normal incidence on the reflective optical element 112. Further, at the predetermined position, the sighting axis 150 of the total station 10 may be substantially parallel to a normal of a reflective surface of the reflective optical element 112. For instance, when the sighting axis 150 is in the predetermined position, the sighting axis 150 may be directed along the second axis 140 towards the reflective optical element 112.

The light source control function 1604 is configured to control the light source to emit a light beam. The light source control function 1604 may be configured to control the second measuring device 1052. The image sensor control function 1606 is configured to control the image sensor to capture an image. The image sensor control function 1606 may be configured to control the first measuring device 1050 and/or the third measuring device 1054. Thus, when the sighting axis 150 of the total station 10 is at the predetermined position, the light source control function 1604 may control the light source such that the light beam is emitted, and the image sensor control function 1606 may control the image sensor to capture an image. In the image, the light beam which has been reflected at the reflective optical element 112 may be visible. To that end, the light source control function 1604 may be configured to adjust an intensity of the light beam. For instance, the intensity of the light beam may be adjustable. Hence, the light source may be an adjustable light source. For instance, in case the light source comprises a light-emitting diode (LED), the intensity of light emitted from the LED may be electrically adjustable. Additionally, or alternatively, the light source control function 1604 may be further configured to control an attenuator configured to attenuate the light beam. The skilled person is aware of suitable attenuators that may be used. For instance, neutral density filters may be used to attenuate the light beam. The light source control function 1604 may be configured to move one or more neutral density filters such that the light beam is attenuated. For instance, the one or more neutral density filters may be mounted on a motorized stage (e.g., a motorized wheel) which may be controlled by the light source control function 1604. Further, the image sensor control function 1606 may be configured to adjust an exposure time associated with the image sensor. Put differently, the image sensor control function 1606 may control an amount of time that the image sensor actively measures (and potentially sums) incident energy from the light beam. Thus, depending on the intensity of the light beam, the amount of time that the image sensor may be exposed to the image sensor may be set such that the light beam is visible in the image. Further, the image sensor control function 1606 may be configured to adjust an integration time of the image sensor. The position identification function 1608 is configured to identify a position of the light beam in the image. The position identification function 1608 may be configured to automatically identify the position of the light beam in the image. The identified position may be determined from pixels in the image having a color value corresponding to the light beam. The identified position may be determined from pixels in the image having a pixel value (corresponding to intensity) within a pixel value range. The pixel value range may represent a range of expected pixel values that the light beam may have in the image. For instance, the identified position may be determined from pixels in the image having pixel values close to, or at, a highest pixel value among pixels of the image. Put differently, the identified position may be determined from pixels in the image having pixel values that are among the highest in the image. The position identification function 1608 may be configured to receive input from a user of the total station 10, and identify the position of the light beam in the image from the input from the user of the total station 10. For instance, the image may be displayed to the user (e.g., on a control device and/or on a screen of the total station 10), and the user may select the position of the light beam in the image. However, this may typically be done automatically as described previously.

The internal calibration reference determination function 1610 is configured to determine an internal calibration reference of the total station 10 based on the determined alignment error of the optical axis 1030, 1032, 1034 of the reference measurement channel and the identified position of the light beam in the image. In case it is found that the determined alignment error of the optical axis 1030, 1032, 1034 of the reference measurement channel is small (or even non-existent), the internal calibration reference may be the identified position of the light beam in the image. In this context, “small” should be understood as an alignment error sufficiently small such that it is not distinguishable during operation (i.e., during measurements) of the total station 10. In case the determined alignment error of the optical axis 1030, 1032, 1034 of the reference measurement channel is large, the internal calibration reference may be determined by compensating the identified position of the light beam in the image with the determined alignment error of the optical axis 1030, 1032, 1034 of the reference measurement channel. Put differently, the identified position of the light beam in the image may be compensated such that the compensated position may correspond to a position at which the light beam would be positioned in case the alignment error of the optical axis 1030, 1032, 1034 of the reference measurement channel relative to the sighting axis 150 of the total station 10 was small (or even non-existent). In this context, “large” should be understood as an alignment error large enough such that it is noticeable during normal operation (i.e., during measurements) of the total station 10. Thus, the internal calibration reference is determined which allows the total station 10 to be calibrated (or its calibration verified) without using an external calibration reference (e.g., an external target). Put differently, the external calibration reference used when determining the alignment error of the optical axis 1030, 1032, 1034 of the reference measurement channel relative to the sighting axis 150 of the total station 10 is transferred to the internal calibration reference, and an external calibration reference may be no longer needed when calibrating the total station 10. Thus, a more efficient and less time-consuming calibration (or calibration verification) of the total station 10 is allowed.

The circuitry 160 may be further configured to execute a calibration function 1612. The calibration function 1612 may be configured to rotate the sighting axis 150 of the total station 10 about the rotation point to the predetermined position. This predetermined position may be the same position as when the internal calibration reference was determined. When the sighting axis 150 of the total station 10 is at the predetermined position, the calibration function 1612 may be further configured to control the light source to emit a light beam and to control the image sensor to capture a second image. This second image may be captured in the same manner as the image captured when the internal calibration reference was determined. The calibration function 1612 may be configured to control one or more of the first measuring device 1050, the second measuring device 1052, and the third measuring device 1054. The calibration function 1612 may be further configured to identify a position of the light beam in the second image, and to compare the identified position of the light beam in the image with the internal calibration reference, and thereby determine an alignment error of an optical axis 1030, 1032, 1034 of the reference measurement channel relative to the sighting axis 150 of the total station 10. Put differently, the total station 10 may be calibrated without needing an external calibration reference (e.g., an external target). It is further to be understood that an already performed calibration of the total station 10 may be validated. To that end, the circuitry 160 may be further configured to execute a calibration validation function 1618 configured to validate the alignment of the optical axis 1030, 1032, 1034 of the reference measurement channel relative to the sighting axis 150 of the total station 10. Upon the calibration validation function 1618 determining that the alignment error determined by the calibration function 1612 is outside a range of approved alignment error values, the calibration validation function 1618 may be configured to alert a user of the total station 10. For instance, the user of the total station 10 may be alerted that the determined alignment error cannot be compensated for, and that a new calibration using an external calibration reference (e.g., an external target) may be needed. Further, the user of the total station 10 may be alerted that the determined alignment error exists and that it can be compensated for, and thereby that no new calibration using the external calibration may be needed.

In the above, the alignment error of the optical axis 1030, 1032, 1034 of the reference channel has been discussed, and optical axes 1030, 1032, 1034 of other measurement channels of the plurality 102 of measurement channels may also experience alignment errors relative to the sighting axis 150 of the total station 10. Therefore, a relative alignment error of the optical axes 1030, 1032, 1034 of the other measurement channels relative to the reference measurement channel may be determined. In particular, a relative alignment error of the optical axis 1032 of the measurement channel 1022 comprising the light source and the optical axis 1030, 1034 of the measurement channel 1020, 1024 comprising the image sensor may advantageously be determined. This, since one of these measurement channels may be the reference measurement channel, and another of these measurement channels is used together with the reference measurement channel to determine the internal calibration reference. Hence, in case a relative alignment error exists, this may affect the determination of the internal calibration reference, and, hence, potentially any calibration (or validation) made using the internal calibration reference. One manner in which the relative alignment error of the optical axis 1032 of the measurement channel 1022 comprising the light source and the optical axis 1030, 1034 of the measurement channel 1020, 1024 comprising the image sensor will now be described.

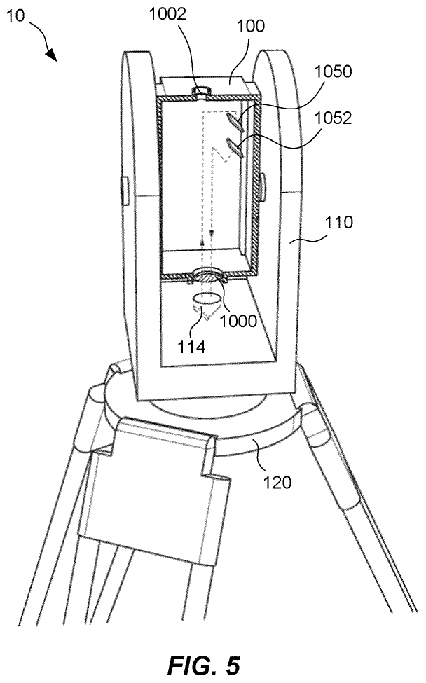

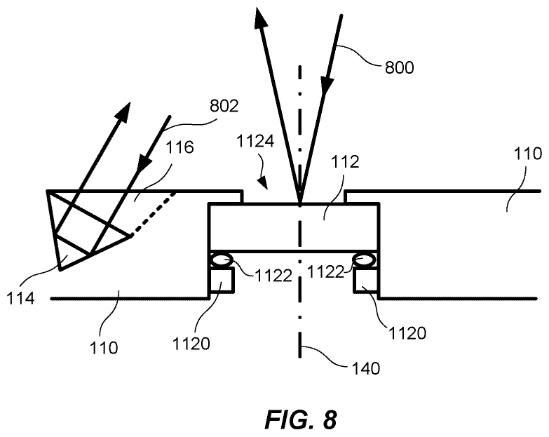

To this end, the total station 10 may, as is illustrated in FIG. 5, further comprise a retroreflecting optical element 114 and the circuitry 160 may be further configured to execute a relative alignment error determination function 1614. The retroreflecting optical element 114 may be configured to retroreflect light. Put differently, a light beam reflected by the retroreflecting optical element 114 may (after reflection) be parallel to the incident light beam. In FIG. 5, several features are not illustrated. For instance, the reflecting optical element 112 described above is not visible. This is done only for illustrative purposes, and it is to be understood that one or more of the excluded features (such as the reflective optical element 112) indeed may be present in the total station illustrated in FIG. 5. It is also to be understood that the reflecting optical element 112 and the retroreflecting optical element 114 may be arranged at different positions (e.g., in the alidade 110). Preferably, the reflecting optical element 112 may be arranged such that a normal of the reflecting surface of the reflecting optical element 112 may be substantially parallel to the second axis 140, and the retroreflecting optical element 114 may be arranged such that a normal of an entrance surface of the retroreflecting optical element 144 may be oriented at an angle to the second axis 140. For instance, the reflecting optical element 112 and the retroreflecting optical element 114 may be arranged as illustrated in FIG. 8. FIG. 8 schematically illustrates a cross section of a portion of the alidade 110. As is seen in the example of FIG. 8, the reflecting optical element 112 may be attached to the alidade 112 using a spring clamp 1120 and an O-ring 1122. The alidade 112 may comprise a hole 1124 whereby the light beam (represented by line 800 in FIG. 8) exiting the objective 1000 of the center unit 100 may reach the reflective optical element 112 when the sighting axis 150 is at the predetermined position (i.e., directed towards the reflecting optical element 112). Further, as is indicated in FIG. 8, the retroreflecting optical element 114 may be recessed in the alidade 110. In order for the light beam (represented by line 802) to reach the recessed retroreflecting optical element 114 when the sighting axis 150 is at the further predetermined position (i.e., directed towards the retroreflecting optical element 114), the alidade 110 may comprise a recess 116 which may allow the light beam to propagate to and be retroreflected by the retroreflecting optical element 114. For reference, the second axis 140 is illustrated in FIG. 8.

The retroreflecting optical element 114 may be a retroreflector. The retroreflecting optical element 114 may be a corner cube prism. The retroreflecting optical element 114 may be fixedly coupled to the alidade 110 (as is the case in FIG. 5) or to the base 120. In case the retroreflecting optical element 114 is fixedly coupled to the base 120, the alidade 110 may comprise a through hole such that the light beam may reach the retroreflecting optical element 114. The relative alignment error determination function 1614 may be configured to determine a relative alignment error of the optical axis 1032 of the measurement channel 1022 comprising the light source and the optical axis 1030, 1034 of the measurement channel 1020, 1024 comprising the image sensor. The relative alignment error determination function 1614 may be configured to rotate the sighting axis 150 of the total station 10 about the rotation point to a further predetermined position at which a light beam emitted from the light source may exit the center unit 100 via the objective 1000 of the center unit 100 and, after reflection at the retroreflecting optical element, may enter the center unit 100 via the objective 1000 for propagation towards the image sensor. Hence, the retroreflecting optical element 114 may be arranged such that, when the sighting axis 150 is at the further predetermined position, a light beam emitted by the light source may be incident on the retroreflecting optical element 114. The further predetermined position of the sighting axis 150 may be a further predetermined direction of the sighting axis 150. The relative alignment error determination function 1614 may be further configured to control the light source to emit a light beam, and to control the image sensor to capture a further image. The relative alignment error determination function 1614 may be configured to control one or more of the first measuring device 1050, the second measuring device 1052, and the third measuring device 1054.

The relative alignment error determination function 1614 may be further configured to determine, based on a position of the light beam in the further image, the relative alignment error of the optical axis 1032 of the measurement channel 1022 comprising the light source and the optical axis 1030, 1034 of the measurement channel 1020, 1024 comprising the image sensor. Since the retroreflecting optical element 114 may reflect the light beam back towards its source, the reflected light beam may propagate along the same optical path (although reversed) as the light beam after being emitted by the light source, and a portion of the reflected light beam may propagate to the image sensor. How the light beam, after entering the center unit 100 via the objective 1000, may arrive at the image sensor has been described above in connection with the determination of the internal calibration reference, and the same principles may apply to this situation as well. However, since the retroreflecting optical element 114 may be configured such that the incident light beam and the reflected light beam may be parallel to each other, the reflected light beam may be parallel to the optical axis 1032 of the measurement channel 1022 comprising the light source. Thus, the reflected light beam may be used to relate the optical axis 1032 of the measurement channel 1022 comprising the light source to the optical axis 1030, 1034 of the measurement channel 1020, 1024 comprising the image sensor. Through this relation, the relative alignment error of the optical axis 1032 of the measurement channel 1022 comprising the light source and the optical axis 1030, 1034 of the measurement channel 1020, 1024 comprising the image sensor may be determined. In particular, in case the image sensor is comprised in a camera having imaging optics configured to image objects at infinity, light beams propagating at an angle relative to the optical axis 1030, 1034 of the measurement channel 1020, 1024 comprising the image sensor may be imaged at a point (e.g., a pixel or a group of pixels) on the image sensor. In other words, different positions on the image sensor may correspond to different angles of the light beam relative to the optical axis 1030, 1034 of the measurement channel 1020, 1024 comprising the image sensor, whereby the relative alignment error of the optical axis 1032 of the measurement channel 1022 comprising the light source and the optical axis 1030, 1034 of the measurement channel 1020, 1024 comprising the image sensor may be determined from the position of the light beam on the image sensor. It is further to be understood that the relative alignment of the optical axis 1032 of the measurement channel 1022 comprising the light source and the optical axis 1030, 1034 of the measurement channel 1020, 1024 comprising the image sensor may be verified. To that end, the circuitry 160 may be configured to execute a relative alignment verification function 1616. The relative alignment verification function 1616 may be configured to determine a current relative alignment error of the optical axis 1032 of the measurement channel 1022 comprising the light source and the optical axis 1030, 1034 of the measurement channel 1020, 1024 comprising the image sensor. The current relative alignment error may be determined in the same manner as the relative alignment error described previously. The relative alignment verification function 1616 may be further configured to verify a relative alignment of the optical axis 1032 of the measurement channel 1022 comprising the light source and the optical axis 1030, 1034 of the measurement channel 1020, 1024 comprising the image sensor by comparing the current relative alignment error with the relative alignment error determined by the relative alignment error determination function 1614. For instance, the position of the light beam on the image sensor when the current relative alignment error was determined may be compared to the position of the light beam in the further image. Thus, a difference between these positions may be related to a difference between the current relative alignment error and the relative alignment error. In case the difference between these positions is outside a range of approved differences (e.g., the difference is too large), the verification may fail and the relative alignment verification function 1616 may be configured to alert the user of the total station 10 of such. In case the difference between these positions is inside the range of approved differences, the verification may succeed and the relative alignment verification function 1616 may be configured to alert the user of the total station of such.

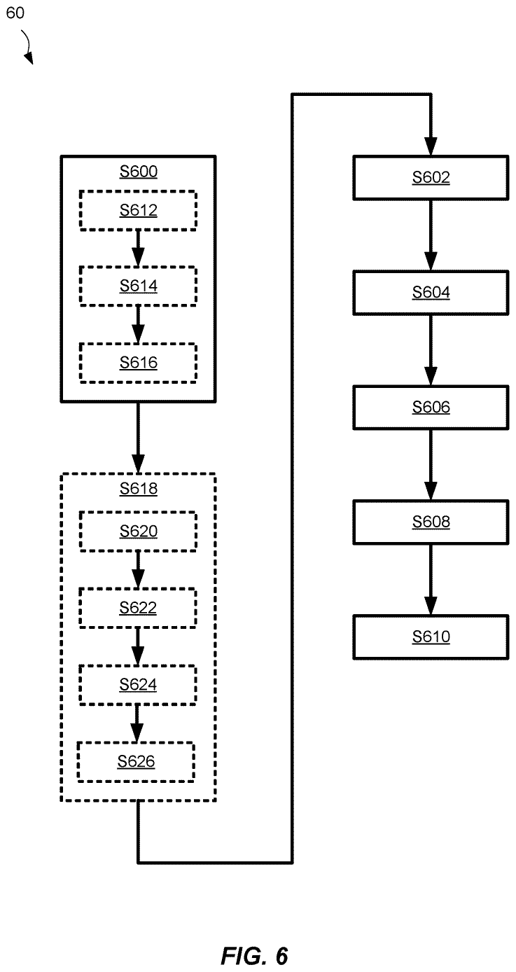

FIG. 6 is a box scheme of a method 60 for determining an internal calibration reference for a total station 10. The total station 10 comprising a center unit 100 mounted on an alidade 110 for rotation about a first axis 130, wherein the alidade 110 is mounted on a base 120 of the total station 10 for rotation about a second axis 140 orthogonal to the first axis 130, whereby a sighting axis 150 of the total station 10 is rotatable about a rotation point, wherein the center unit 100 comprises a plurality 102 of measurement channels, each measurement channel 1020, 1022, 1024 having an optical axis 1030, 1032, 1034, wherein at least one measurement channel 1022 of the plurality 102 of measurement channels comprises a light source, and wherein at least one measurement channel 1020, 1024 of the plurality 102 of measurement channels comprises an image sensor. The method 60 comprising: determining S600 an alignment error of an optical axis 1030, 1032, 1034 of a reference measurement channel relative to the sighting axis 150 of the total station 10, wherein the reference measurement channel is a measurement channel 1022 comprising the light source or a measurement channel 1020, 1024 comprising the image sensor; rotating S602 the sighting axis 150 of the total station 10 about the rotation point to a predetermined position at which a light beam emitted from the light source exits the center unit 100 via an objective 1000 of the center unit 100 and, after reflection at a reflective optical element 112 fixedly coupled to the alidade 110, enters the center unit 100 via the objective 1000 for propagation towards the image sensor; emitting S604 a light beam from the light source; capturing S606 an image with the image sensor; identifying S608 a position of the light beam in the image; and determining S610 an internal calibration reference of the total station 10 based on the determined alignment error of the optical axis 1030, 1032, 1034 of the reference measurement channel and the identified position of the light beam in the image. The reflective optical element 112 may be a mirror configured to specularly reflect light emitted by the light source. An angle of incidence of the light beam at the reflective optical element 112 may be smaller than an angle corresponding to a field-of-view associated with the image sensor when the sighting axis 150 of the total station 10 is at the predetermined position. The reference measurement channel may be associated with a measuring device 1050, 1052, 1054, and determining S600 the alignment error of the optical axis 1030, 1032, 1034 of the reference measurement channel may comprise: performing S612, using the measuring device 1050, 1052, 1054 associated with the reference measurement channel, a first measurement in a first face of the total station 10; performing S614, using the measuring device 1050, 1052, 1054 associated with the reference measurement channel, a second measurement in a second face of the total station 10, wherein, in the second face, the center unit 100 may be rotated around each one of the first axis 130 and the second axis 140 of the total station 10 by 180° compared to the first face; and comparing S616 the first measurement and the second measurement, whereby the alignment error of an optical axis 1030, 1032, 1034 of the reference measurement channel relative to the sighting axis 150 of the total station 10 may be determined. The reference measurement channel may be the measurement channel 1022 comprising the image sensor. The measurement channel 1022 comprising the light source and the measurement channel 1020, 1024 comprising the image sensor may be different measurement channels. The method 60 may further comprise: determining S618 a relative alignment error of the optical axis 1032 of the measurement channel 1022 comprising the light source and the optical axis 1030, 1034 of the measurement channel 1020, 1024 comprising the image sensor. Determining S618 a relative alignment error of the optical axis 1032 of the measurement channel 1022 comprising the light source and the optical axis 1030, 1034 of the measurement channel 1020, 1024 comprising the image sensor may comprise: rotating S620 the sighting axis 150 of the total station 10 about the rotation point to a further predetermined position at which a light beam emitted from the light source may exit the center unit 100 via the objective 1000 of the center unit 100 and, after reflection at a retroreflecting optical element 114, may enter the center unit 100 via the objective 1000 for propagation towards the image sensor; emitting S622 a light beam from the light source; capturing S624 a further image with the image sensor; and determining S626, based on a position of the light beam in the further image, the relative alignment error of the optical axis 1032 of the measurement channel 1022 comprising the light source and the optical axis 1030, 1034 of the measurement channel 1020, 1024 comprising the image sensor.

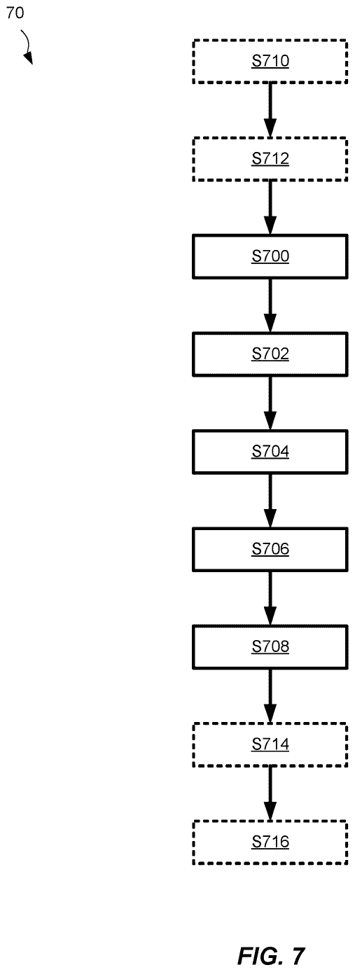

FIG. 7 is a box scheme of a calibration method 70 for a total station 10 using an internal calibration reference determined according to the method 60 illustrated in FIG. 6. The total station 10 comprises a center unit 100 mounted on an alidade 110 for rotation about a first axis 130, wherein the alidade 110 is mounted on a base 120 of the total station 10 for rotation about a second axis 140 orthogonal to the first axis 130, whereby a sighting axis 150 of the total station 10 is rotatable about a rotation point, wherein the center unit 100 comprises a plurality 102 of measurement channels, each measurement channel 1020, 1022, 1024 having an optical axis 1030, 1032, 1034, wherein at least one measurement channel 1022 of the plurality 102 of measurement channels comprises a light source, and wherein at least one measurement channel 1020, 1024 of the plurality 102 of measurement channels comprises an image sensor. The calibration method 70 comprising: rotating S700 the sighting axis 150 of the total station 10 about the rotation point to a predetermined position at which the internal calibration reference is determined and at which a light beam emitted from the light source exits the center unit 100 via an objective 1000 of the center unit 100 and, after reflection at a reflective optical element 112, enters the center unit 100 via the objective 1000 for propagation towards the image sensor; emitting S702 a light beam from the light source; capturing S704 an image with the image sensor; identifying S706 a position of the light beam in the image; and comparing S708 the identified position of the light beam in the image with the internal calibration reference, thereby determining an alignment error of an optical axis 1030, 1032, 1034 of a reference measurement channel relative to the sighting axis 150 of the total station 10. In turn, by determining the alignment error of the optical axis 1030, 1032, 1034 of the reference measurement channel relative to the sighting axis 150 of the total station 10, the optical axis 1032 of the measurement channel 1022 comprising the light source or the optical axis 1030, 1034 of a measurement channel 1020, 1024 comprising the image sensor may be calibrated relative to the sighting axis 150 of the total station 10. The calibration method 70 may further comprise: determining S710 a current relative alignment error of the optical axis 1032 of the measurement channel 1022 comprising the light source and the optical axis 1030, 1034 of the measurement channel 1020, 1024 comprising the image sensor; and verifying S712 a relative alignment of the optical axis 1032 of the measurement channel 1022 comprising the light source and the optical axis 1030, 1034 of the measurement channel 1020, 1024 comprising the image sensor by comparing the current relative alignment error with the relative alignment error determined according to the method 60 illustrated in FIG. 6. The calibration method 70 may further comprise: comparing S714 the determined alignment error of the optical axis 1030, 1032, 1034 of the reference measurement channel relative to the sighting axis 150 of the total station 10 with a range of allowed threshold errors; and upon the determined alignment error being outside the range of allowed threshold errors: alarming S716 a user of the total station 10 that the determined alignment error of the optical axis 1030, 1032, 1034 of the reference measurement channel relative to the sighting axis 150 of the total station 10 is outside the range of allowed threshold errors.

The person skilled in the art realizes that the present inventive concept by no means is limited to the preferred variants described above. On the contrary, many modifications and variations are possible within the scope of the appended claims.

For example, the total station 10 has been described as having three measurement channels (i.e., the measurement channels 1020, 1022, 1024 comprising the light source and the image sensor, respectively). It is however to be understood that the total station 10 (i.e., the center unit 100) may comprise additional measurement channels.

Additionally, variations to the disclosed variants can be understood and effected by the skilled person in practicing the claimed invention, from a study of the drawings, the disclosure, and the appended claims.

1. A method for determining an internal calibration reference for a total station, the total station comprising a center unit mounted on an alidade for rotation about a first axis, wherein the alidade is mounted on a base of the total station for rotation about a second axis orthogonal to the first axis, whereby a sighting axis of the total station is rotatable about a rotation point, wherein the center unit comprises a plurality of measurement channels, each measurement channel having an optical axis wherein at least one measurement channel of the plurality of measurement channels comprises a light source, and wherein at least one measurement channel of the plurality of measurement channels comprises an image sensor, the method comprising:
determining an alignment error of an optical axis of a reference measurement channel relative to the sighting axis of the total station, wherein the reference measurement channel is a measurement channel comprising the light source or a measurement channel, comprising the image sensor;
rotating the sighting axis of the total station about the rotation point to a predetermined position at which a light beam emitted from the light source exits the center unit via an objective of the center unit and, after reflection at a reflective optical element fixedly coupled to the alidade, enters the center unit via the objective for propagation towards the image sensor;
emitting a light beam from the light source;
capturing an image with the image sensor;
identifying a position of the light beam in the image; and
determining an internal calibration reference of the total station based on the determined alignment error of the optical axis of the reference measurement channel and the identified position of the light beam in the image.

2. The method according to claim 1, wherein the reflective optical element is a mirror configured to specularly reflect light emitted by the light source.

3. The method according to claim 1, wherein an angle of incidence of the light beam at the reflective optical element is smaller than an angle corresponding to a field-of-view associated with the image sensor when the sighting axis of the total station is at the predetermined position.

4. The method according to claim 1, wherein the reference measurement channel is associated with a measuring device and determining the alignment error of the optical axis of the reference measurement channel comprises:
performing, using the measuring device associated with the reference measurement channel, a first measurement in a first face of the total station;
performing, using the measuring device associated with the reference measurement channel, a second measurement in a second face of the total station, wherein, in the second face, the center unit is rotated around each one of the first axis and the second axis of the total station by 180° compared to the first face; and
comparing the first measurement and the second measurement, whereby the alignment error of the optical axis of the reference measurement channel relative to the sighting axis of the total station is determined.

5. The method according to claim 1, wherein the reference measurement channel is the measurement channel comprising the image sensor.

6. The method according to claim 1, wherein the measurement channel comprising the light source and the measurement channel comprising the image sensor are different measurement channels.

7. The method according to claim 6, further comprising:
determining a relative alignment error of the optical axis of the measurement channel comprising the light source and the optical axis of the measurement channel comprising the image sensor.

8. The method according to claim 7, wherein determining the relative alignment error of the optical axis of the measurement channel comprising the light source and the optical axis of the measurement channel comprising the image sensor comprises:
rotating the sighting axis of the total station about the rotation point to a further predetermined position at which a light beam emitted from the light source exits the center unit via the objective of the center unit and, after reflection at a retroreflecting optical element, enters the center unit via the objective for propagation towards the image sensor;
emitting a light beam from the light source;
capturing a further image with the image sensor; and
determining, based on a position of the light beam in the further image, the relative alignment error of the optical axis of the measurement channel comprising the light source and the optical axis of the measurement channel comprising the image sensor.

9. A calibration method for a total station using an internal calibration reference determined according to the method of claim 1, wherein the total station comprises a center unit mounted on an alidade for rotation about a first axis , wherein the alidade is mounted on a base of the total station for rotation about a second axis orthogonal to the first axis, whereby a sighting axis of the total station is rotatable about a rotation point, wherein the center unit comprises a plurality of measurement channels, each measurement channel having an optical axis wherein at least one measurement channel of the plurality of measurement channels comprises a light source, and wherein at least one measurement channel of the plurality of measurement channels comprises an image sensor, the calibration method comprising:
rotating the sighting axis of the total station about the rotation point to a predetermined position at which the internal calibration reference is determined and at which a light beam emitted from the light source exits the center unit via an objective of the center unit and, after reflection at a reflective optical element, enters the center unit via the objective for propagation towards the image sensor;
emitting a light beam from the light source;
capturing an image with the image sensor;
identifying a position of the light beam in the image; and
comparing the identified position of the light beam in the image with the internal calibration reference, thereby determining an alignment error of an optical axis of a reference measurement channel relative to the sighting axis of the total station.

10. The calibration method according to claim 9, further comprising:
determining a current relative alignment error of the optical axis of the measurement channel comprising the light source and the optical axis of the measurement channel comprising the image sensor; and
verifying a relative alignment of the optical axis of the measurement channel comprising the light source and the optical axis of the measurement channel comprising the image sensor by comparing the current relative alignment error with a relative alignment error-determined of the optical axis of the measurement channel comprising the light source and the optical axis of the measurement channel comprising the image sensor.

11. The calibration method according to claim 9, further comprising:
comparing the determined alignment error of the optical axis of the reference measurement channel relative to the sighting axis of the total station with a range of allowed threshold errors; and
upon the determined alignment error being outside the range of allowed threshold errors:
alarming a user of the total station that the determined alignment error of the optical axis of the reference measurement channel relative to the sighting axis of the total station is outside the range of allowed threshold errors.

12. A total station comprising:
a center unit comprising a plurality of measurement channels, each measurement channel having an optical axis wherein at least one measurement channel of the plurality of measurement channels comprises a light source, and wherein at least one measurement channel of the plurality of measurement channels comprises an image sensor;
an alidade on which the center unit is mounted for rotation about a first axis;
a base on which the alidade is mounted for rotation about a second axis orthogonal to the first axis, whereby a sighting axis of the total station is rotatable about a rotation point;
a reflective optical element fixedly coupled to the alidade; and
circuitry configured to execute:
an alignment error determination function configured to determine an alignment error of an optical axis of a reference measurement channel relative to the sighting axis of the total station, wherein the reference measurement channel is a measurement channel comprising the light source or a measurement channel comprising the image sensor,
a rotation function configured to rotate the sighting axis of the total station about the rotation point to a predetermined position at which a light beam emitted from the light source exits the center unit via an objective of the center unit and, after reflection at the reflective optical element, enters the center unit via the objective for propagation towards the image sensor,
a light source control function configured to control the light source to emit a light beam,
an image sensor control function configured to control the image sensor to capture an image,
a position identification function configured to identify a position of the light beam in the image, and
an internal calibration reference determination function configured to determine an internal calibration reference of the total station based on the determined alignment error of the optical axis of the reference measurement channel and the identified position of the light beam in the image.

13. The total station according to claim 12, wherein the reflective optical element is a mirror configured to specularly reflect light emitted by the light source.

14. The total station according to claim 12, wherein an angle of incidence of the light beam at the reflective optical element is smaller than an angle corresponding to a field-of-view associated with the image sensor when the sighting axis of the total station is at the predetermined position.

15. The total station according to claim 12, wherein the reference measurement channel is associated with a measuring device and wherein the alignment error determination function is configured to determine an alignment error of an optical axis of the reference measurement channel relative to the sighting axis of the total station by being configured to:
perform, using the measuring device associated with the reference measurement channel, a first measurement in a first face of the total station;
rotate the center unit about the rotation point to a second face of the total station, wherein, in the second face, the center unit is rotated around each one of the first axis and the second axis of the total station by 180° compared to the first face;
perform, using the measuring device associated with the reference measurement channel, a second measurement in the second face of the total station; and
compare the first measurement and the second measurement, whereby the alignment error of an optical axis of the reference measurement channel relative to the sighting axis of the total station is determined.

16. The total station according to claim 12, wherein the reference measurement channel is the measurement channel comprising the image sensor.

17. The total station according to claim 12, wherein the circuitry is further configured to execute:
a calibration function configured to:
rotate the sighting axis of the total station about the rotation point to the predetermined position;
control the light source to emit a light beam;
control the image sensor to capture a second image;
identify a position of the light beam in the second image; and
compare the identified position of the light beam in the image with the internal calibration reference, thereby determining an alignment error of an optical axis of a reference measurement channel relative to the sighting axis of the total station.

18. The total station according to claim 12, wherein the measurement channel comprising the light source and the measurement channel comprising the image sensor are different measurement channels.

19. The total station according to claim 18, wherein the circuitry is further configure to execute:
a relative alignment error determination function configured to determine a relative alignment error of the optical axis of the measurement channel comprising the light source and the optical axis of the measurement channel comprising the image sensor.

20. The total station according to claim 19, wherein the total station further comprises:
a retroreflecting optical element; and
wherein the relative alignment error determination function is configured to determine the relative alignment error of the optical axis of the measurement channel comprising the light source and the optical axis of the measurement channel comprising the image sensor by being configured to:
rotate the sighting axis of the total station about the rotation point to a further predetermined position at which a light beam emitted from the light source exits the center unit via the objective of the center unit and, after reflection at the retroreflecting optical element, enters the center unit via the objective for propagation towards the image sensor,
control the light source to emit a light beam,
control the image sensor to capture a further image, and
determine, based on a position of the light beam in the further image, the relative alignment error of the optical axis of the measurement channel comprising the light source and the optical axis of the measurement channel comprising the image sensor.

21. The total station according to claim 19, wherein the circuitry is further configured to execute:
a relative alignment verification function configured to:
determine a current relative alignment error of the optical axis of the measurement channel comprising the light source and the optical axis of the measurement channel comprising the image sensor, and
verify a relative alignment of the optical axis of the measurement channel comprising the light source and the optical axis of the measurement channel comprising the image sensor by comparing the current relative alignment error with the relative alignment error determined by the relative alignment error determination function.
